(19) United States
(12) Patent Application Publication
(10) Pub. No.: US 2017/0021700 A1
(43) Pub. Date: Jan. 26, 2017

(54) METHOD OF PREVENTING DAMAGE TO A COMPRESSOR IN A VEHICLE

(71) Applicant: FORD GLOBAL TECHNOLOGIES, LLC, Dearborn, MI (US)

(72) Inventors: Mark G. Smith, Canton, MI (US); Timothy Noah Blatchley, Dearborn, MI (US)

(21) Appl. No.: 14/806,966

(22) Filed: Jul. 23, 2015

(51) Int. Cl. B60H 1/32; F01P 7/14; F01P 11/10; F01P 7/04

(52) U.S. Cl. CPC B60H 1/3225; F01P 7/04; F01P 7/14; F01P 11/10

(57) ABSTRACT

A method of preventing damage to a compressor in a vehicle is provided. The method broadly includes the steps of: (a) sensing a temperature (T_{D}) of a compressor discharge fluid; (b) identifying a time (tₐ) when the sensed temperature (T_{D}) is greater than a first threshold temperature (T₁); (c) initiating a first action at a time (t₁) if the sensed temperature (T_{D}) remains greater than the first threshold temperature (T₁); (d) initiating a second action at a time (t₂) if the sensed temperature (T_{D}) remains greater than the first threshold temperature (T₁); (e) initiating a third action at a time (t₃) if the sensed temperature (T_{D}) remains greater than the first threshold temperature (T₁); and (f) initiating a fourth action at a time (t₄) if the sensed temperature (T_{D}) remains greater than the first threshold temperature (T₁). The method may further include the step of turning the compressor off when the sensed temperature (T_{D}) of the compressor discharge fluid is greater than a second threshold temperature (T₂).

### TECHNICAL FIELD

This document relates generally to vehicle heating/cooling systems, and more specifically to a method of preventing damage to a compressor of a heating/cooling system.

### BACKGROUND

It is known that the temperature of a discharge fluid of a vehicle compressor is an indicator of the compressor's status. In other words, a high discharge temperature may indicate a deficiency within the heating/cooling system and if unaddressed could result in damage to the compressor. It is known to utilize a controller to switch a compressor on and off depending on comparison of a sensed, or an estimated, temperature and a threshold temperature, or more simply a time-limiting value. In these scenarios, the compressor is simply switched off, by removing power, disengaging a clutch of the compressor or otherwise, for a period in order to avoid overheating.

In one particular system described in U.S. Pat. No. 8,152,475 to Sorge, a method of controlling a compressor in which the compressor is switched on/off by a control unit to avoid heat related damage is described. In this system and related method, the compressor is switched off if an estimated temperature is above a pre-determined maximum threshold temperature for a calibration time period. At initiation, however, the compressor is allowed to be switched on if the estimated temperature is at or below a minimum threshold temperature, and the compressor is allowed to continue to operate even when the estimated temperature is above the pre-determined minimum threshold temperature but below the pre-determined maximum threshold temperature.

While these systems and methods are adequate to provide protection for a vehicle compressor against temperature related issues, simply turning the compressor on and off according to a certain temperature may result in unnecessary stoppage of the compressor in certain instances caused by transient driving conditions, transient ambient conditions, or other like conditions. Accordingly, a need exists for a more robust method of preventing damage to a compressor. For instance, the method may incorporate a period of time after a sensed temperature exceeds a threshold temperature before taking any action to ensure that the reason for the elevated sensed temperature is not transient in nature. In addition, the method would take intermediate steps to reduce the sensed temperature once the threshold temperature is reached and a period of time has lapsed before turning the compressor off after a second threshold temperature is reached. Such a method would also preferably initiate the intermediate steps sequentially or could initiate one or more of the steps at the same time. Even more, the intermediate steps may be different depending upon whether the vehicle is operating in a cooling or heating mode.

### SUMMARY OF THE INVENTION

In accordance with the purposes and benefits described herein, a method is provided of preventing damage to a compressor in a vehicle. The method may be broadly described as comprising the steps of: (a) sensing a temperature (T_{D}) of a compressor discharge fluid; (b) incrementing a time (tₐ) when the sensed temperature (T_{D}) is greater than a first threshold temperature (T₁); (c) initiating a first action at a time (t₁) if the sensed temperature (T_{D}) remains greater than the first threshold temperature (T₁); (d) initiating a second action at a time (t₂) if the sensed temperature (T_{D}) remains greater than the first threshold temperature (T₁); (e) initiating a third action at a time (t₃) if the sensed temperature (T_{D}) remains greater than the first threshold temperature (T₁); and (f) initiating a fourth action at a time (t₄) if the sensed temperature (T_{D}) remains greater than the first threshold temperature (T₁).

In one possible embodiment, the method further includes the step of turning the compressor off when the sensed temperature (T_{D}) of the compressor discharge fluid is greater than a second threshold temperature (T₂) for a predetermined period of time (t_{β}).

In another possible embodiment, the vehicle is operating in a cooling mode, and the first action is opening active grill shutters of the vehicle.

In yet another possible embodiment, the second action is increasing a speed of an engine cooling fan of the vehicle. In another, the third action is reducing a speed of the compressor of the vehicle, and in still another, the fourth action is opening an expansion device to reduce an amount of superheat of a gas entering the compressor.

In one other possible embodiment, wherein the vehicle is operating in a cooling mode, the first action includes opening active grill shutters of the vehicle and increasing a speed of an engine cooling fan of the vehicle.

In another possible embodiment, wherein the vehicle is operating in a heating mode, the first action is increasing a flow rate of a coolant pump of the vehicle. In another, the second action is reducing a speed of the compressor of the vehicle. In yet another, the third action is increasing an airflow through a heater core of the vehicle, and in still another, the fourth action is opening an heating expansion device to reduce an amount of superheat of a gas entering the compressor.

In accordance with a second aspect of the invention, a method is provided of preventing damage to a compressor in a vehicle operating in a cooling mode. The method may be broadly described as comprising the steps of: (a) sensing a temperature (T_{D}) of a compressor discharge fluid; and (b) opening active grill shutters of the vehicle if the sensed temperature (T_{D}) is greater than a first threshold temperature (T₁).

In another embodiment, the method of preventing damage to a compressor in a vehicle operating in a cooling mode may further include the step of turning the compressor off when the sensed temperature (T_{D}) of the compressor discharge fluid is greater than a second threshold temperature (T₂) for a predetermined period of time (t_{β}).

In still another embodiment, the method of preventing damage to a compressor in a vehicle operating in a cooling mode may further include the steps of incrementing a time (tₐ) when the sensed temperature (T_{D}) is greater than a first threshold temperature (T₁), and initiating a further action (n) at a time (tₙ) if the sensed temperature (T_{D}) remains greater than the first threshold temperature (T₁).

In yet another embodiment, the method of preventing damage to a compressor in a vehicle operating in a cooling mode may further include the step(s) of initiating at least one additional action (n) at time (tₙ) if the sensed temperature (T_{D}) remains greater than the first threshold temperature (T₁), where n=2, 3, . . . m, and m is the number of actions.

In accordance with still another possible embodiment, a vehicle operable in heating and cooling modes includes a compressor, a sensor associated with the compressor for sensing a temperature of a discharge fluid of the compressor, and a controller programmed to determine whether the sensed temperature (T_{D}) is greater than a first threshold temperature (T₁), to increment a time (tₐ) when the sensed temperature (T_{D}) becomes greater than the first threshold temperature (T₁), to initiate a first action at a time (t₁) if the sensed temperature (T_{D}) remains greater than the first threshold temperature (T₁), a second action at a time (t₂) if the sensed temperature (T_{D}) remains greater than the first threshold temperature (T₁), a third action at a time (t₃) if the sensed temperature (TD) remains greater than the first threshold temperature (T₁), and a fourth action at a time (t₄) if the sensed temperature (T_{D}) remains greater than the first threshold temperature (T₁).

In another embodiment, the controller is programmed to turn the compressor off when the sensed temperature (T_{D}) of the compressor discharge fluid is greater than a second threshold temperature (T₂) for a predetermined period of time (t_{β}).

In yet another embodiment, the vehicle operable in heating and cooling modes includes active grill shutters, and the controller is programmed, in the cooling mode, to open the active grill shutters if the sensed temperature (T_{D}) is greater than the first threshold temperature (T₁).

In still another embodiment, the vehicle operable in heating and cooling modes includes active grill shutters, an engine cooling fan, and a cooling expansion device, and, in the cooling mode, the first action is opening the active grill shutters, the second action is increasing a speed of the engine cooling fan, the third action is reducing a speed of the compressor, and the fourth action is opening the cooling expansion device to reduce an amount of superheat of a gas entering the compressor.

In one other embodiment, the vehicle operable in heating and cooling modes includes a refrigerant to coolant heat exchanger, a coolant pump for moving coolant through the refrigerant to coolant heat exchanger, a heater core for heating a cabin of the vehicle, and a heating expansion device, and, in the heating mode, the first action is increasing a flow rate of the coolant pump, the second action is reducing a speed of the compressor, the third action is increasing an airflow through the heater core, and the fourth action is opening the heating expansion device to reduce an amount of superheat of the gas entering the compressor.

In the following description, there are shown and described several embodiments of a method of preventing damage to a compressor in a vehicle and a vehicle operating in heating and cooling modes incorporating same. As it should be realized, the methods and systems are capable of other, different embodiments and their several details are capable of modification in various, obvious aspects all without departing from the methods and assemblies as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the vehicle and method and together with the description serve to explain certain principles thereof. In the drawing figures:

FIG. 1 is a schematic diagram of a vehicle cooling and heating system;

FIG. 2 is a flow chart schematic for preventing damage to a compressor in a vehicle;

FIG. 3 is a graphical representation of three possible temperature curves representing a sensed compressor discharge fluid temperature; and

FIG. 4 is a block diagram of a controller, compressor, and vehicle components operated upon by the controller depending upon the temperature sensed by the temperature sensor.

Reference will now be made in detail to the present preferred embodiments of the method of preventing damage to a compressor in a vehicle, examples of which are illustrated in the accompanying drawing figures, wherein like numerals are used to represent like elements.

### DETAILED DESCRIPTION

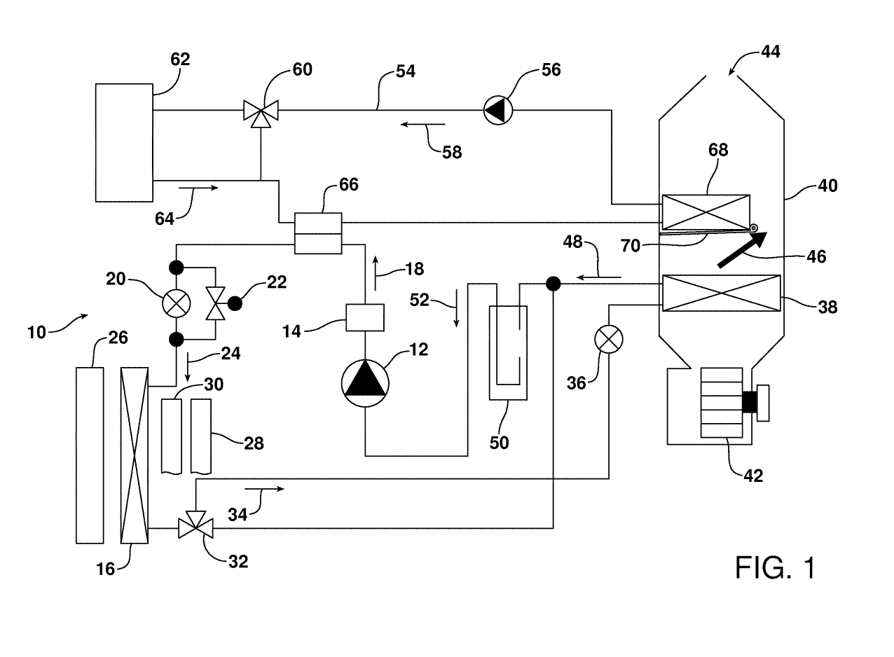

Reference is now made to FIG. 1 which illustrates a schematic diagram of a typical vehicle cooling and heating system 10 including a compressor 12. In the described embodiment, the compressor is an electric compressor utilized in hybrid vehicles. Alternate embodiments may utilize a variable displacement compressor or a traditional compressor driven by a compressor belt (not shown) which in turn is driven by a crankshaft (not shown) of the vehicle. In operation, the compressor 12 compresses a fluid, which is a refrigerant in the described embodiment, thereby raising a temperature (T) of the fluid. A temperature sensor 14 associated with the compressor 12 senses a temperature (TD) of the fluid discharged from the compressor. The temperature sensor 14 is shown in the described embodiment in a downstream position from the compressor 12. However, the temperature sensor 14 could be positioned further downstream from the position shown, directly adjacent the compressor 12, or even within the compressor in alternate embodiments.

The vehicle cooling and heating system 10 operates in a commonly known manner except for control of the compressor 12 and certain actions taken to control various components within the system to prevent damage to the compressor. These components and the actions controlling them are described in more detail below. Broadly speaking, a condenser 16 is positioned in the described embodiment at a front section of an engine compartment and cools high-temperature, high-pressure gas refrigerant supplied from the compressor 12 as shown by action arrow 18. The refrigerant passes through a first (heating) expansion device 20 or a shutoff valve 22 prior to passing through the condenser 16 as shown by action arrow 24.

In cooling mode, the heating expansion device 20 is set to a bypass mode thus having substantially no effect on the refrigerant. Within the outside heat exchanger 16, the refrigerant is condensed due primarily to the effect of outside air, and liquefied. As shown, the vehicle includes active grill shutters 26 which control an amount of air allowed to pass over the outside heat exchanger 16. A fan 28 is also utilized in the described embodiment to create and regulate the flow of air through the active grill shutters 26, over the outside heat exchanger 16 and an engine radiator 30. The active grill shutters 26 and fan 28 are components that are controlled in order to prevent damage to the compressor 12.

The high pressure, liquefied refrigerant is then sent through a three way valve 32, as shown by action arrow 34, to a second (cooling) expansion device 36. In the cooling expansion device 36, the high-temperature, high-pressure refrigerant is expanded to become a low-temperature, low-pressure liquid and vapor refrigerant mixture, and this low-temperature, low-pressure fluid refrigerant is supplied to an evaporator 38. Regulation of the flow of refrigerant, or throttling, is used to control the temperature of refrigerant within the evaporator 38. Increasing the flow of refrigerant necessarily lowers the temperature.

The evaporator 38 is typically positioned within an HVAC case of the vehicle and is used to cool a passenger compartment of the vehicle. Warm, moist air flowing across the evaporator 38 transfers its heat to the cooler refrigerant within the evaporator. The byproducts are a lowered temperature air and condensation from the air which is routed from the evaporator 38 to an exterior of the vehicle. A blower 42 blows air across the evaporator 38 and through a vent 44, as shown by action arrow 46, to the passenger compartment. This process results in the passenger compartment having a cooler, drier air therein.

The low pressure refrigerant exits the evaporator 38, as shown by action arrow 48, and liquid is accumulated in the accumulator 50 to prevent liquid from entering the compressor 12. A low pressure, gas refrigerant exits the accumulator 50, as shown by action arrow 52, and is received in the compressor 12 where the refrigerant is again compressed and cycled through the system 10.

The system 10 further includes an engine cooling portion designated 54 including a coolant pump 56 that pumps coolant or antifreeze, as shown by action arrow 58, through a second three way valve 60 and the engine 62. The coolant draws heat from the engine 62 and routes the heated coolant, as shown by action arrow 64, through a refrigerant to coolant heat exchanger 66 before entering a heater core 68 positioned within the vehicle HVAC case. In heating mode, a blend door 70 is used to regulate the flow of air created by the blower 42 allowing air to travel through, or partially through, the heater core 68. While the described embodiment includes a heat pump system, alternate embodiments could include a conventional air conditional system.

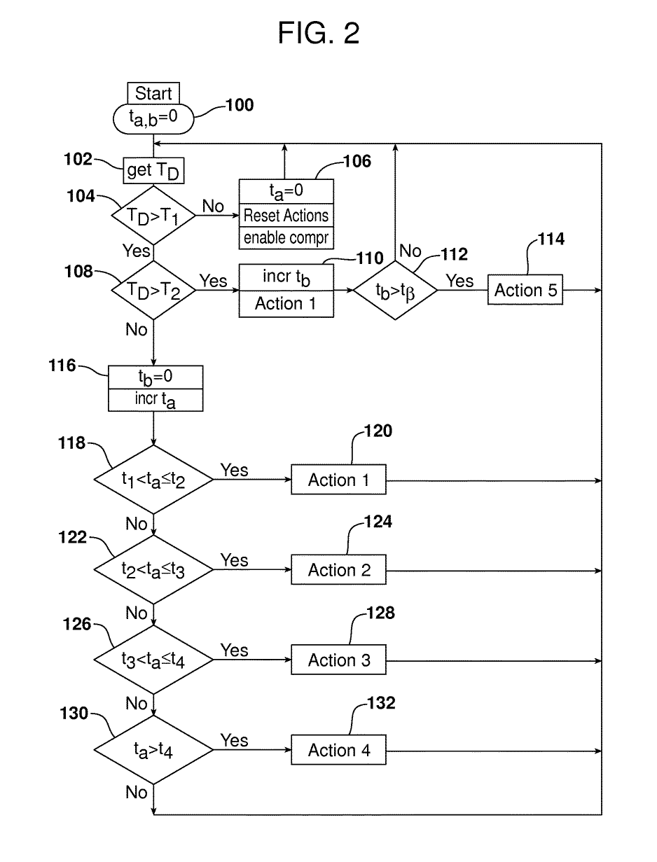

The steps utilized in the described embodiment will be described with reference to FIG. 2. FIG. 2 is a flowchart of operational control of the cooling and heating system 10 of the vehicle according to the described embodiment. The processing sequence related to operational control of the cooling and heating system 10 according to the described embodiment is executed by a processor 76 of controller 74 as a program stored in memory 78. Upon initiation of the sequence, timers Tₐ and T_{b} within the controller 74 are initiated setting times tₐ and t_{b} to “0” at Step 100, and a sensed temperature (T_{D}) of the compressor refrigerant discharge is acquired by temperature sensor 14 at Step 102. Next, the sensed temperature (T_{D}) is compared to a first threshold temperature (T₁) at Step 104. If the sensed temperature (T_{D}) is less than the first threshold temperature (T₁), the time tₐ is reset to “0,” actions which may have previously been taken are reset, and the compressor 12 is enabled or turned on if it were in a disabled or off state at Step 106. Upon completion of these tasks, the sequence returns to Step 102 and acquires a sensed temperature (T_{D}) of the compressor refrigerant discharge.

If the sensed temperature (T_{D}) is more than the first threshold temperature (T₁) at Step 104, then the sensed temperature (T_{D}) is compared by controller 74 to a second threshold temperature (T₂) at Step 108. If the sensed temperature (T_{D}) is greater than the second threshold temperature (T₂), then time t_{b} is incremented at Step 110 and Action 1 is taken in order to lower the sensed temperature (T_{D}). In alternate embodiments, one or more of Actions (e.g., Action 1 through Action n) may be taken in order to lower the sensed temperature (T_{D}) at this point or at any point before the time t_{b} is greater than or equal to a predetermined time t_{β}.

If the time t_{b} is less than the predetermined time t_{β} at Step 112, then the sequence returns to Step 102, acquires a sensed temperature (T_{D}) of the compressor refrigerant discharge from temperature sensor 14, and compares the sensed temperature (T_{D}) to the first and second threshold temperatures (T₁) and (T₂) at Steps 104 and 108 as described above. If taking Action 1, in the described embodiment, results in the sensed temperature (T_{D}) falling below the first and second threshold temperatures (T₁) and (T₂), then no further action is required and Action 1 items are reset in Step 106. For clarity, it should be noted that time t_{β} is independent of times t₁, t₂, t₃, t₄ . . . tₙ described throughout the specification and is not necessarily greater than t₄, for example.

If the sensed temperature (T_{D}) remains greater than the second threshold temperature (T₂) until time t_{b} is greater than the predetermined time t_{β} at Step 112, then Action 5 is taken at Step 114. In the described embodiment, Action 5 is turning the compressor 12 off to prevent damage thereto. Once the compressor 12 is turned off, the sequence continues to monitor the sensed temperature (T_{D}) and compare (T_{D}) to the first and second threshold temperatures (T₁) and (T₂) until the sensed temperature (T_{D}) is lowered to a temperature at least less than (T₁) in the described embodiment.

At this point, the time tₐ is reset to “0,” actions which may have previously been taken are reset, and the compressor 12 is enabled or turned on at Step 106. Upon completion of these tasks, the sequence returns to Step 102 and continues monitoring by acquiring a sensed temperature (T_{D}) of the compressor refrigerant discharge. In alternate embodiments, the actions occurring at Step 106 could occur when the sensed temperature (T_{D}) is lowered to a temperature at least less than (T₂), and possibly between (T₂) and (T₁). Alternatively, the compressor 12 may be shut down for a predetermined period of time to ensure proper cooling, or the temperature (T_{D}) of the compressor refrigerant discharge may continue to be sensed until the temperature (T_{D}) falls below an additional predetermined temperature and possibly for a predetermined period of time.

If the sensed temperature (T_{D}) is more than the first threshold temperature (T₁) but less than the second threshold temperature (T₂) at Step 108, then time t_{b} is reset to “0” and time tₐ is incremented at Step 116. In the described embodiment, the term increment is defined as setting the time (e.g., tₐ) to an elapsed amount of time since the timer to was initialized to zero as shown at Step 100. In other words, the time tₐ is incremented, or set to equal, to the time elapsed since the timer was initialized. This time is kept by a clock of the controller while the sequence is run. In alternate embodiments, however, a time tₐ may be incremented, in the traditional sense, by a predetermined amount of time (e.g., 100 milliseconds) each pass through the sequence. Returning to the described embodiment, if time tₐ is greater than a predetermined time t₁ and less than or equal to a second predetermined time t₂ at Step 118, then Action 1 is taken at Step 120 and the sequence returns to Step 102, acquires a sensed temperature (T_{D}), and compares the sensed temperature (T_{D}) to the first predetermined temperature (T₁) at Step 104.

If time tₐ is less than the predetermined time t₁ at Step 118, then the predetermined time tₐ is further compared in Steps 122, 126, and 130 to t₂, t₃, and t₄ respectively. Since each time t₂, t₃, and t₄ is greater than t₁ in the described embodiment, time tₐ is necessarily determined to be less than each and the sequence returns to Step 102, acquires a sensed temperature (T_{D}), and compares the sensed temperature (T_{D}) to the first predetermined temperature (T₁) at Step 104. It should be noted, however, that times t₁, t₂, t₃, and t₄, for example, could be the same or combinations of them the same (e.g., t₁=t₂) while the remaining times t₃ and t₄ vary.

If time tₐ is greater than the predetermined time t₁ and greater than the predetermined time t₂ at Step 118, then the time tₐ is further compared in Step 122. If time tₐ is greater than the predetermined time t₂ and less than or equal to the predetermined time t₃ at Step 122, then Action 2 is taken at Step 124 and the sequence returns to Step 102, acquires a sensed temperature (T_{D}), and compares the sensed temperature (T_{D}) to the first predetermined temperature (T₁) at Step 104.

If time tₐ is greater than the predetermined time t₂ and greater than the predetermined time t₃ at Step 122, then the time tₐ is further compared in Step 126. If time tₐ is greater than the predetermined time t₃ and less than or equal to a predetermined time t₄ at Step 126, then Action 3 is taken at Step 128 and the sequence returns to Step 102, acquires a sensed temperature (T_{D}), and compares the sensed temperature (T_{D}) to the first predetermined temperature (T₁) at Step 104.

If time tₐ is greater than the predetermined time t₃ and greater than the predetermined time t₄ at Step 126, then the time tₐ is further compared in Step 130 to t₄. If time tₐ is greater than the predetermined time t₄ at Step 130, then Action 4 is taken at Step 132 and the sequence returns to Step 102, acquires a sensed temperature (T_{D}), and compares the sensed temperature (T_{D}) to the first predetermined temperature (T₁) at Step 104.

In accordance with the broad teaching of the present invention, an alternate embodiment may include any number of actions (e.g., Actions 1, 2, 3, 4, . . . m). After taking the fourth action, for example, the controller 74 may continue in a sequence similar to that described above with regard to predetermined temperatures t₁ through t₄ until an n^{th} predetermined period of time (tₙ) has elapsed.

For example, if time tₐ is greater than the predetermined time t₄ and greater than an n^{th} predetermined time (tₙ), then the predetermined time tₐ is further compared to the predetermined time tₙ₊₁. If time tₐ is greater than the predetermined time tₙ and less than or equal to the next predetermined time tₙ, then Action n is taken and the sequence returns to Step 102, acquires a sensed temperature (T_{D}), and compares the sensed temperature (T_{D}) to the first predetermined temperature (T₁) at Step 104.

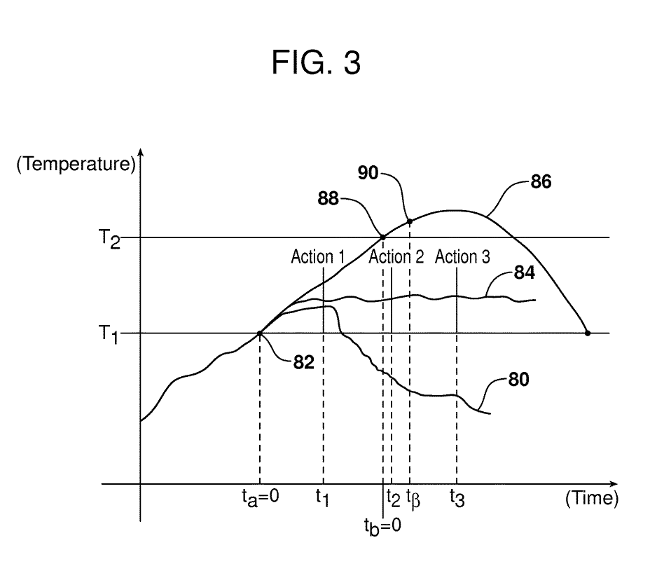

The described embodiment is further depicted graphically in FIG. 3. As described above, a sensed temperature (T_{D}) of the compressor refrigerant discharge fluid is acquired by a temperature sensor 14. As shown, the sensed temperature (T_{D}) can fluctuate depending on varying conditions, including changes in the ambient conditions associated with the vehicle and/or conditions created through the taking of Actions 1, 2, 3, 4, . . . m.

As shown in FIG. 3, a first temperature curve 80 increases from an initial temperature at time to along time line (t) during operation of the vehicle. At a point 82, the sensed temperature (T_{D}), shown by curve 80, is equal to and then exceeds a first threshold temperature (T₁). In the described embodiment, a timer Tₐ is initialized, i.e., tₐ=0, when the sensed temperature (T_{D}) rises above the first threshold temperature (T₁). The timer Tₐ is used to delay taking any actions until a period of time (e.g., t₁) has elapsed after the sensed temperature (T_{D}) has increased above the first threshold temperature (T₁) as shown at point 82.

If the sensed temperature (T_{D}) remains greater than the first threshold temperature (T₁) and below a second threshold temperature (T₂) upon the elapse of a predetermined period of time (t₁), then a first action, Action 1, is taken in order to lower the sensed temperature (T_{D}). If taking Action 1 results in the sensed temperature (T_{D}) falling below the first threshold temperature (T₁) at or before a predetermined period of time (t₂) as shown by first temperature curve 80, then no further action is required and Action 1 items are reset from the adjustments made at time t₁.

In an alternate embodiment, when the sensed temperature (T_{D}) has been above the first threshold temperature (T₁) for a period of time and then falls below the first threshold temperature (T₁), a hysteresis may be utilized to hold the Action 1 requested for a period of time (tₕ) or until a certain change in temperature occurs. In other words, the hysteresis ensures that the sensed temperature (T_{D}) is sufficiently below the first threshold temperature (T₁) before Action 1 is cancelled to prevent rapid on and off cycles resulting from repeated triggering of Action 1.

If the sensed temperature (T_{D}) remains above the first threshold temperature (T₁) and below the second threshold temperature (T₂) at predetermined period of time (t₂) as shown by a second temperature curve 84, then a second action, Action 2, is taken to lower the sensed temperature (T_{D}). In the described embodiment, as shown, up to n actions may be taken if the sensed temperature (T_{D}) remains above the first threshold temperature (T₁) and below the second threshold temperature (T₁) at successive times (t₃, t₄, . . . tₙ, tₙ₊₁). This scenario is illustrated by the second temperature curve 84.

In the event the sensed temperature (T_{D}) rises above the second threshold temperature (T₂) as shown by a third temperature curve 86, then the controller 74 acts to shut down the compressor 12 to prevent damage. In the described embodiment, a timer t_{b} is initialized, i.e., t_{b}=0, when the sensed temperature (T_{D}) rises above the second threshold temperature (T₂) as shown at point 88. The timer t_{b} is used to delay turning the compressor 12 off until a period of time (t_{β}) has elapsed after the sensed temperature (T_{D}) has increased above the second threshold temperature (T₂) as shown at point 90. The compressor may be shut down for a pre-determined period of time to ensure proper cooling or the temperature (T_{D}) of the compressor refrigerant discharge may continue to be sensed until the temperature (T_{D}) falls below the first threshold temperature (T₁) or another pre-determined temperature. Alternatively, the compressor 12 may remain off until a predetermined time after the temperature (T_{D}) falls below the first threshold temperature (T₁) or another pre-determined temperature.

As generally set forth above, the described invention takes one or more actions in response to a sensed temperature (T_{D}) exceeding first and second threshold temperatures (T₁ and T₂) in order to prevent damage to the vehicle compressor 12. The actions (1, 2, 3, 4, . . . n) are dependent upon whether the vehicle is operating in a cooling mode or a heating mode and may include, for example, stopping the compressor 12, slowing a speed of the compressor 12, opening the heating expansion device 20 so that less superheat of a gas enters a suction port of the compressor, turning one or more fans 28 on or to higher settings or speeds to decrease the pressure ratio across the compressor, opening or further opening the vehicle's active grill shutters 26 (if applicable), and/or ensuring that the coolant pump 56 is drawing current/voltage in order to establish that the pump is in an on state.

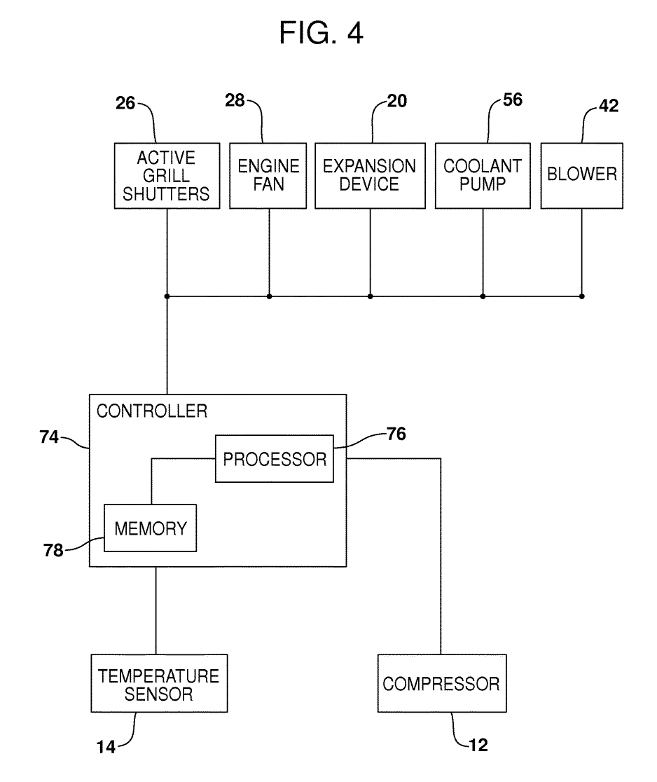

As shown in FIG. 4, the controller 74 monitors a temperature (T_{D}) sensed by temperature sensor 14. A processor 76, running the above-described sequence that is stored in memory 78 within the controller 74, then generates signals controlling the operation of varying components of the vehicle (e.g., Actions 1-4), including compressor 12. In the described embodiment, each Action 1-4 affects a single component of the vehicle. For example, Action 1 includes fully opening the vehicle's active grill shutters 26 while Action 2 includes turning the vehicle's engine cooling fan 28 to a maximum speed setting. Action 3, if necessary, includes reducing a speed of the compressor 12. A PI control method may be utilized to maintain the sensed temperature (T_{D}) of the compressor refrigerant discharge fluid at the first threshold temperature (T₁) and Action 4, in the described embodiment, includes setting the heating expansion device 20, which is an electronic expansion valve, to a minimum superheat operating point. In an alternate embodiment, one or more of the Actions 1-4 may affect more than one component of the vehicle. For example, Action 1 could include fully opening the vehicle's active grill shutters 26 and turning the vehicle's engine cooling fan 28 to a predetermined speed setting.

Action 5, in the described embodiment, is turning the compressor 12 to an off state. Alternate embodiments may include such other items as altering a speed of the vehicle's active grill shutters 26 and/or the cooling fan. In the broadest sense, any action that assists in lowering the temperature (T_{D}) of the fluid discharged from the compressor 12 could be taken as part of Action 5. In the event the sensed temperature (T_{D}) of the compressor refrigerant discharge fluid exceeds the second threshold temperature (T₂) at any point, then the compressor 12 is turned to an off state. This may occur immediately or following a predetermined period of time. As indicated above, the described invention takes one or more actions in response to a sensed temperature (T_{D}).

Four actions are utilized in the described embodiment in the cooling mode of operation, including two actions that are taken simultaneously, but more or fewer actions may be taken in accordance with the invention. Even more, the time periods for taking the actions may be any times including identical time periods, slightly different, and/or separated by a predetermined period of time. For example, Actions 1 and 2 could occur simultaneously at a time t₁=t₂, or at slightly different times (e.g., t₁=1.0000 seconds and t₂=1.0001 seconds), or at times separated by a predetermined period of time (e.g., 30 seconds) where t₁=1.0 second and t₂=31.0 seconds.

In the described embodiment in the heating mode of operation, Action 1, if necessary, includes setting a cooling pump 56 to a maximum flow rate/speed. Action 2 includes reducing a speed of the compressor 12. As in the cooling mode, a PI control method may be utilized to maintain the sensed temperature (T_{D}) of the compressor refrigerant discharge at the first threshold temperature (T₁). Action 3 includes both increasing the HVAC airflow over the heater core 68 by increasing a speed of blower 38 and/or moving blend door 70, and increasing the use of outside air intake, as opposed to, recirculated air intake by adjusting the vehicle venting. Action 4, in the described embodiment, includes setting the heating expansion device 20 between the refrigerant to coolant heat exchanger 66 and the condenser 16 to a calculated larger opening position, i.e., a lower superheat setting.

In the event the sensed temperature (T_{D}) of the compressor refrigerant discharge gas exceeds the second threshold temperature (T₂) and t_{b}>t_{β}, then the compressor 12 is turned to an off state. As with the cooling mode of operation, more or fewer actions may be taken in accordance with the invention. Even more, the time periods for taking the actions may be any time including identical time periods, slightly different, and/or separated by a predetermined period of time as described above with regard to the cooling mode.

In summary, numerous benefits result from the method of preventing damage to a compressor in a vehicle as illustrated in this document. The method is capable of preventing damage while allowing transient conditions to pass without interfering with vehicle operation. For example, the method incorporates a period of time after a sensed temperature exceeds a threshold temperature before taking any action to ensure that the reason for the elevated sensed temperature is not transient in nature. In addition, the method takes intermediate steps to reduce the sensed temperature once the threshold temperature is reached and a period of time had lapsed before turning the compressor off after a second threshold temperature is reached. The method also initiates the intermediate steps sequentially or at the same time as desired. Even more, the intermediate steps are different depending upon whether the vehicle is operating in a cooling or heating mode.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A method of preventing damage to a compressor in a vehicle, comprising the steps of:
sensing a temperature (T_{D}) of a compressor discharge fluid;
incrementing a time (tₐ) when the sensed temperature (T_{D}) is greater than a first threshold temperature (T₁);
initiating a first action at a time (t₁) if the sensed temperature (T_{D}) remains greater than the first threshold temperature (T₁);
initiating a second action at a time (t₂) if the sensed temperature (T_{D}) remains greater than the first threshold temperature (T₁);
initiating a third action at a time (t₃) if the sensed temperature (T_{D}) remains greater than the first threshold temperature (T₁); and
initiating a fourth action at a time (t₄) if the sensed temperature (T_{D}) remains greater than the first threshold temperature (T₁).

2. The method of preventing damage to a compressor in a vehicle of claim 1, further comprising the step of turning the compressor off when the sensed temperature (T_{D}) of the compressor discharge fluid is greater than a second threshold temperature (T₂) for a predetermined period of time (t_{β}).

3. The method of preventing damage to a compressor in a vehicle of claim 2, wherein the vehicle is operating in a cooling mode, and the first action is opening active grill shutters of the vehicle.

4. The method of preventing damage to a compressor in a vehicle of claim 3, wherein the second action is increasing a speed of an engine cooling fan of the vehicle.

5. The method of preventing damage to a compressor in a vehicle of claim 4, wherein the third action is reducing a speed of the compressor of the vehicle.

6. The method of preventing damage to a compressor in a vehicle of claim 5, wherein the fourth action is opening an expansion device to reduce an amount of superheat of a gas entering the compressor.

7. The method of preventing damage to a compressor in a vehicle of claim 1, wherein the vehicle is operating in a cooling mode, and the first action includes opening active grill shutters of the vehicle and increasing a speed of an engine cooling fan of the vehicle.

8. The method of preventing damage to a compressor in a vehicle of claim 2, wherein the vehicle is operating in a heating mode, and the first action is increasing a flow rate of a coolant pump of the vehicle.

9. The method of preventing damage to a compressor in a vehicle of claim 8, wherein the second action is reducing a speed of the compressor of the vehicle.

10. The method of preventing damage to a compressor in a vehicle of claim 9, wherein the third action is increasing an airflow through a heater core of the vehicle.

11. The method of preventing damage to a compressor in a vehicle of claim 10, wherein the fourth action is opening a heating expansion device to reduce an amount of superheat of a gas entering the compressor.

12. A method of preventing damage to a compressor in a vehicle operating in a cooling mode, comprising the steps of:
sensing a temperature (T_{D}) of a compressor discharge fluid; and
opening active grill shutters of the vehicle if the sensed temperature (T_{D}) is greater than a first threshold temperature (T₁).

13. The method of preventing damage to a compressor in a vehicle operating in a cooling mode of claim 12, further comprising the step of turning the compressor off when the sensed temperature (T_{D}) of the compressor discharge fluid is greater than a second threshold temperature (T₂) for a predetermined period of time (t_{β}).

14. The method of preventing damage to a compressor in a vehicle operating in a cooling mode of claim 13, further comprising the steps of incrementing a time (tₐ) when the sensed temperature (T_{D}) is greater than the first threshold temperature (T₁) and less than the second threshold temperature (T₂); and initiating a further action (n) at a time (tₙ) if the sensed temperature (T_{D}) remains greater than the threshold temperature (T₁).

15. The method of preventing damage to a compressor in a vehicle operating in a cooling mode of claim 14, further comprising the steps of initiating at least one additional action (n) at a time (tₙ) if the sensed temperature (T_{D}) remains greater than the threshold temperature (Ti), where n=1, 2, 3, . . . m.

16. A vehicle operable in heating and cooling modes, comprising:
a compressor;
a sensor associated with said compressor for sensing a temperature (T_{D}) of a discharge fluid of said compressor; and
a controller programmed to determine whether the sensed temperature (T_{D}) is greater than a first threshold temperature (T₁), to increment a time (tₐ) when the sensed temperature (TD) becomes greater than the first threshold temperature (T₁), to initiate a first action at a time (t₁) if the sensed temperature (T_{D}) remains greater than the first threshold temperature (T₁), a second action at a time (t₂) if the sensed temperature (T_{D}) remains greater than the first threshold temperature (T₁), a third action at a time (t₃) if the sensed temperature (T_{D}) remains greater than the threshold temperature (T₁), and a fourth action at a time (t₄) if the sensed temperature (T_{D}) remains greater than the first threshold temperature (T₁).

17. The vehicle operable in heating and cooling modes of claim 16, wherein said controller is programmed to turn said compressor off when the sensed temperature (T_{D}) of the compressor discharge fluid is greater than a second threshold temperature (T₂) for a predetermined period of time (t_{β}).

18. The vehicle operable in heating and cooling modes of claim 16, further comprising active grill shutters, and wherein said controller is programmed in the cooling mode to open said active grill shutters if the sensed temperature (T_{D}) is greater than the first threshold temperature (T₁).

19. The vehicle operable in heating and cooling modes of claim 16, further comprising active grill shutters;
an engine cooling fan; and
a cooling expansion device;
wherein, in the cooling mode, the first action is opening said active grill shutters, the second action is increasing a speed of said engine cooling fan, the third action is reducing a speed of said compressor, and the fourth action is opening said cooling expansion device to reduce an amount of superheat of a gas entering said compressor.

20. The vehicle operable in heating and cooling modes of claim 16, further comprising a condenser;
a fluid pump for moving fluid through said refrigerant to coolant heat exchanger;
a heater core for heating a cabin of said vehicle; and
a heating expansion device;
wherein, in the heating mode, the first action is increasing a flow rate of said coolant pump, the second action is reducing a speed of said compressor, the third action is increasing an airflow through said heater core, and the fourth action is opening said heating expansion device to reduce an amount of superheat of the gas entering said compressor.
